(19) United States
(12) Patent Application Publication
(10) Pub. No.: US 2026/0253823 A1
(43) Pub. Date: Aug. 27, 2026

(54) INTERRUPTER UNIT FOR A VACUUM CIRCUIT BREAKER AND VACUUM CIRCUIT BREAKER THEREOF

(71) Applicant: Mitsubishi Electric Power Products, Inc.,, Warrendale, PA (US)

(72) Inventor: Paul J. Vladuchick, Warrendale, PA (US)

(73) Assignee: Mitsubishi Electric Power Products, Inc.,, Warrendale, PA (US)

(21) Appl. No.: 19/063,191

(22) Filed: Feb. 25, 2025

(51) Int. Cl. H01H 33/662

(52) U.S. Cl. CPC H01H 33/66207

(57) ABSTRACT

An interrupter unit for a vacuum circuit breaker includes a vacuum sealed tube and a pair of conductor casings attached to the vacuum sealed tube with the vacuum sealed tube being arranged between conductor casings. At least one of the conductor casings defines a cooling channel. A pair of ground insulators extend from a dead tank to the conductor casings along the central axis of the vacuum sealed tube and support the pair of conductor casings on the dead tank. At least one of the ground insulators defines an inlet passage fluidly coupled to the cooling channel to provide a coolant to the cooling channel, and an outlet passage fluidly coupled to the coolant channel to receive the coolant from the coolant channel.

### TECHNICAL FIELD

The present disclosure relates, generally, to vacuum circuit breakers, and, more particularly, relates to a vacuum circuit breaker having one or more passages formed through one or more ground insulators to enable a flow of coolant to components of the vacuum circuit breaker to efficiently remove heat from the components of the vacuum circuit breaker.

### BACKGROUND

A vacuum circuit breaker (“VCB”) is a device that helps to prevent unintended currents caused by short circuits in electrical systems. It works by interrupting the current after a fault has been detected, thereby preventing damage to the system. Vacuum circuit breakers rely on a vacuum to extinguish the arc created when the circuit is tripped and the contacts move apart. VCBs work quickly and effectively, making them a solid choice for medium-and high-voltage systems.

Dead tank vacuum circuit breakers are high-performance switches that use dry air or other gas as an insulating medium, instead of sulfur hexachloride, a greenhouse gas. These devices are designed to be environmentally conscious and energy-saving, and can operate in extreme conditions. Some applications for dead tank vacuum circuit breakers include line, transformer, reactor, and capacitor switching, point-on-wave switching, as well as high seismic and high altitude applications.

Conventional dead tank vacuum circuit breakers typically include a dead tank and an interrupter unit arranged inside the dead tank with an insulated gas filled inside the dead tank to draw heat away from the interrupter unit and electrically insulate the dead tank from the interrupter unit. To facilitate an opening and closing of an electric circuit, the interrupter unit typically includes a stationary contact and a moving contact, each partially extending inside a vacuum sealed bottle and adapted to engage with each other and disengage from each other inside the vacuum sealed tube to close and open the circuit. Due to high continuous current rating, and reliance on arcing contacts, high amount of heat is generated during normal operation when the circuit is closed, and during opening of the circuit. Effectively drawing this heat away from vacuum circuit breakers (VCBs) is essential for several reasons:

Preventing Overheating: VCBs generate heat during operation, especially when carrying high continuous currents. If this heat isn't dissipated properly, it can lead to overheating, which can damage the VCB and reduce its lifespan.

Maintaining Performance: Excessive heat can limit the performance of the VCB. It can cause thermal expansion, which might lead to mechanical stresses and misalignment of components, impacting the breaker's ability to carry and interrupt current effectively.

Enhancing Efficiency: Efficient heat management ensures that the VCB operates at or below the maximum allowable temperature limits.

Thus, effective heat dissipation is important to ensuring the reliability, safety, and efficiency of vacuum circuit breakers. However, it is difficult to implement, at least because no convection heat transfer is possible within the vacuum sealed bottle.

### SUMMARY

Accordingly, one object of the present disclosure is to effectively remove heat from an interrupter unit of a vacuum circuit breaker. Another object of the present disclosure is to provide a mechanism which increase a rate of heat transfer from arcing contacts of the interrupter unit to prevent an undesired rise of temperatures of the vacuum interrupter bottle and the transfer contacts, and therefore undesired deterioration of the contacts and reduced performance of the vacuum circuit breaker.

The above objects are addressed by enabling a flow of coolant inside the interrupter unit to facilitates an increased heat transfer from arcing contacts of a vacuum circuit breaker. In various embodiments and implementations of the concepts disclosed herein, to increase the heat transfer from the contacts, at least one of the conductor casings includes a cooling channel to allow a flow of the coolant and remove the heat from the conductor casings and the arching contacts. To enable the coolant to flow to the at least one of the conductor casings, the interrupter unit includes an inlet passage and an outlet passage through an associated ground insulator of the interrupter unit. The ground insulators support the conductor casings on the dead tank. The coolant flows from an outside of the dead tank to the colling channel via the inlet passage, and takes heat from the conductor casing and then exit the interrupter unit via the outlet passage, increasing heat removal rate from the conductor casing and the associated contact. However, the passages inside the ground insulator can create discontinuity, resulting in bending and concentration of the electric field lines at the discontinuity of the insulator. Concentration of electric field lines may result into the generation of electric flashes, which is undesirable and may compromise the structural and electrical integrity of the vacuum circuit breaker. To overcome this challenge and prevent electric flashing, the fluid having high dielectric strength, comparable to that of the insulator, and high cooling efficiency is used as coolant through the passages.

Generally, in one aspect, the present disclosure relates to an interrupter unit for a vacuum circuit breaker. The interrupter unit is adapted to be arranged inside a dead tank and supported on the dead tank. The interrupter unit includes a vacuum sealed tube and a pair of conductor casings attached to the vacuum sealed tube and extending outwardly and along a central axis of the vacuum sealed tube. The vacuum sealed tube is arranged between the pair of conductor casings. At least one of the pair of conductor casings defines a cooling channel. Further, the interrupter unit includes a pair of ground insulators extending from the dead tank to the pair of conductor casings along the central axis of the vacuum sealed tube and supporting the pair of conductor casings on the dead tank. At least one of the pair of ground insulators defines an inlet passage fluidly coupled to the cooling channel to provide a coolant to the cooling channel, and an outlet passage fluidly coupled to the coolant channel to receive the coolant from the coolant channel.

In some embodiments, the coolant includes a dielectric strength that is between ninety percent and hundred and ten percent of a dielectric strength of the at least one of the pair of ground insulators.

In another aspect, the disclosure relates to a vacuum circuit breaker that includes a dead tank defining a chamber. The vacuum circuit breaker also includes an interrupter unit arranged inside the chamber and comprises a vacuum sealed tube and a pair of conductor casings attached to the vacuum sealed tube and extending outwardly and along a central axis of the vacuum sealed tube. The vacuum sealed tube is arranged between the pair of conductor casings. Further, at least one of the pair of conductor casing defines a cooling channel. The interrupter unit also includes a pair of ground insulators extending from the dead tank to the pair of conductor casings along the central axis of the vacuum sealed tube and supporting the pair of conductor casings on the dead tank. At least one of the pair of ground insulators defines an inlet passage fluidly coupled to the cooling channel to provide a coolant to the cooling channel, and an outlet passage fluidly coupled to the cooling channel to receive the coolant from the coolant channel.

In some embodiments, the coolant includes a dielectric strength that is between ninety percent and hundred and ten percent of a dielectric strength of the at least one of the pair of ground insulators.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also can appear in any disclosure incorporated by reference should be accorded a meaning most consistent with the particular concepts disclosed herein.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 illustrates a front sectional view of a vacuum circuit breaker, in accordance with an embodiment of the disclosure;

FIG. 2 illustrates a front sectional view of an interrupter unit of the vacuum circuit breaker of FIG. 1, in accordance with an embodiment of the disclosure;

FIG. 3 illustrates an enlarged view of a portion of the interrupter unit of FIG. 2 depicting a cooling channel and inlet and outlet passages associated with cooling of a moving contact of the interrupter unit of FIG. 2, in accordance with an embodiment of the disclosure;

FIG. 4 illustrates an enlarged view of a portion of the interrupter unit of FIG. 2 depicting a cooling channel and inlet and outlet passages associated with cooling of a stationary contact of the interrupter unit of FIG. 2, in accordance with an embodiment of the disclosure;

FIG. 5 illustrates a front sectional view of an interrupter unit, in accordance with an embodiment of the disclosure;

FIG. 6 illustrates a front sectional view of an interrupter unit, in accordance with an embodiment of the disclosure;

FIG. 7 illustrates a front sectional view of a vacuum circuit breaker, in accordance with an embodiment of the disclosure;

FIG. 8 illustrates a front sectional view of an interrupter unit of the vacuum circuit breaker of FIG. 7, in accordance with an embodiment of the disclosure;

FIG. 9 illustrates an enlarged view of a portion of the interrupter unit of FIG. 8 depicting cooling channel, elongated groove, and inlet and outlet passages associated with cooling of a moving contact of the interrupter unit of FIG. 8, in accordance with an embodiment of the disclosure;

FIG. 10 illustrates an enlarged view of a portion of the interrupter unit of FIG. 8 depicting cooling channel, elongated groove, and inlet and outlet passages associated with cooling of a stationary contact of the interrupter unit of FIG. 8, in accordance with an embodiment of the disclosure;

FIG. 11 illustrates a front sectional view of an interrupter unit, in accordance with an embodiment of the disclosure; and

FIG. 12 illustrates a front sectional view of an interrupter unit, in accordance with an embodiment of the disclosure.

### DETAILED DESCRIPTION

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

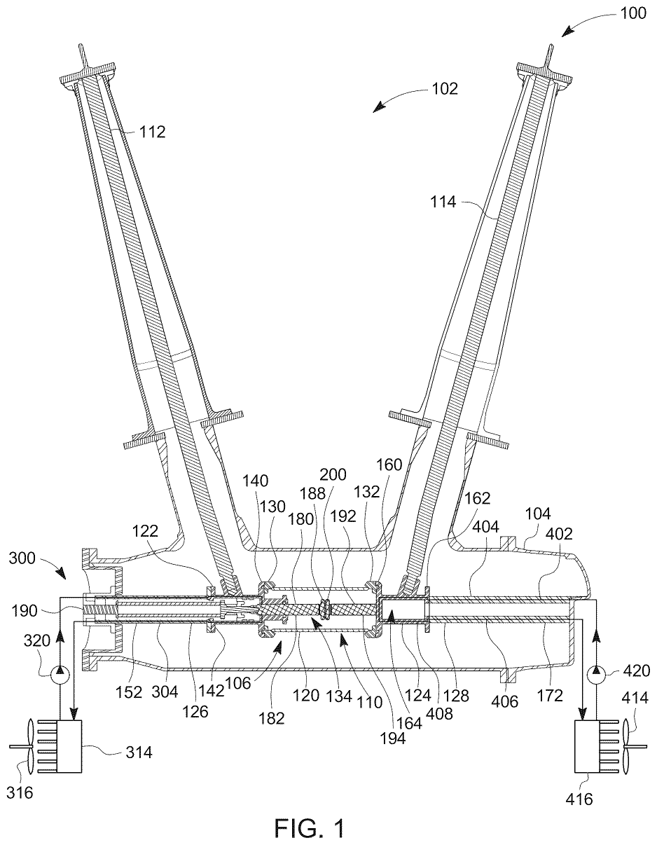

Referring to FIG. 1, a vacuum circuit breaker 100 is shown, according to various embodiments of the present disclosure. The vacuum circuit breaker 100 is illustrated as a dead tank vacuum circuit breaker 102, however, other types of vacuum circuit breakers are also suitable in conjunction with the present disclosure and concepts described herein. As shown, the vacuum circuit breaker 100 (also referred to as breaker 100) includes a dead tank 104 defining a chamber 106, an interrupter unit 110 arranged inside the chamber 106 and supported on the dead tank 104, and a pair of conductors 112, 114 attached to the interrupter unit 110 to electrically couple a first electric equipment and a second electrical equipment. The interrupter unit 110 is arranged to electrically connect and disconnect the first and second electrical equipment and includes a vacuum sealed bottle 120, a first conductor casing 122, a second conductor casing 124, and a pair of ground insulators 126, 128 supporting the interrupter unit 110 on the dead tank 104 and electrically insulating the dead tank 104 from electrically conducting components of the interrupter unit 110.

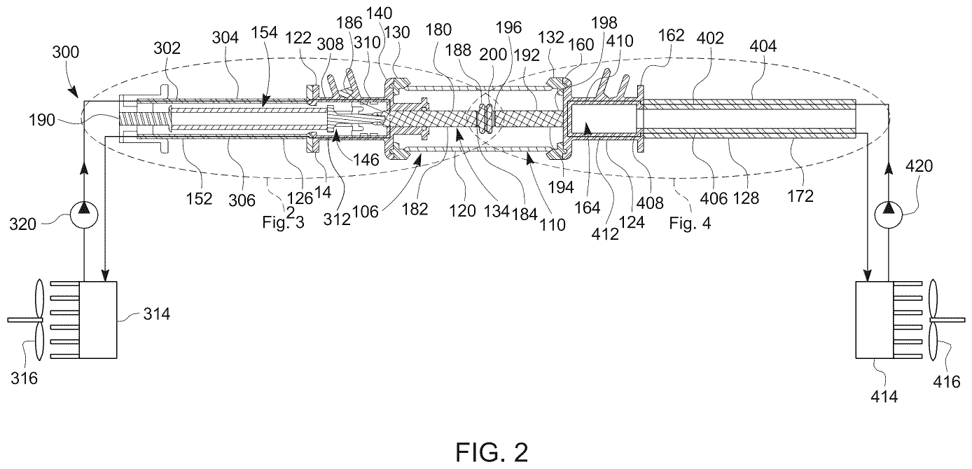

Referring to FIG. 2, the vacuum sealed bottle 120 includes a first axial end 130, a second axial end 132 arranged opposite to the first axial end 130, and a vacuum compartment 134 extending from the first axial end 130 to the second axial end 132. The first conductor casing 122 and the second conductor casing 124 extend outwardly, in an axial direction, from the vacuum sealed bottle 120, and are, respectively, connected/attached to the first axial end 130 and the second axial end 132 of the bottle 120. The first conductor casing 122 and the second conductor casing 124 are formed of electrically conducing material, for example, aluminium, or any other suitable electrically conducting metal or alloy known in the art. A first conductor 112 of the pair of conductors 112, 114 is attached to the first conductor casing 122, while a second conductor 114 of the pair of conductors 112, 114 is attached to the second conductor casing 124, and the first conductor 112 and the second conductor 114 extend outwardly of the dead tank 104 from the associated conductor casings 122, 124.

As shown in FIG. 2, the first conductor casing 122, simply referred to as first casing 122, includes a first end 140 connected to the first axial end 130 of the bottle 120 and a second axial end 142 arranged opposite to the first end 140 of the first casing 122 and disposed proximate to the dead tank 104 relative to the first end 140 in the axial direction of the bottle 120. The first casing 122 defines a cavity, for example, a first cavity 146, with a first access hole of the first cavity 146 arranged at the first end 140 and a second access hole of the first cavity 146 arranged at the second end 142.

The first ground insulator 126 extends from the dead tank 104 to the second end 142 of the first casing 122 and is attached to the first casing 122. In the embodiment, the first ground insulator 126 is an insulator tube 152 extending, in the axial direction of the bottle 120, from the first casing 122 to the dead tank 104 with an end portion of the insulator tube 152 extending inside the first casing 122 through the second access hole. Accordingly, the second access hole and a channel 154 of the insulator tube 152 are coaxially arranged to each other.

Similar to the first casing 122, the second casing 124 includes a first axial end 160 connected to the second axial end 132 of the bottle 120 and a second axial end 162 arranged opposite to the first end 160 and disposed proximate to the dead tank 104 relative to the first end 160 in the axial direction of the bottle 120. The second casing 124 defines a cavity, for example, a second cavity 164, shown in FIGS. 1 and 2. The second ground insulator 128 extends from the dead tank 104 to the second end 162 of the second casing 124 and is attached to the second casing 124. As shown in FIGS. 1 and 2, the second ground insulator 128 is an insulator rod 172 extending, in the axial direction of the bottle 120, from the second casing 124 to the dead tank 104.

Furthermore, the interrupter unit 110 includes a first contact 180, also referred to as a moving contact 180, at least partially arranged inside the bottle 120 and partially arranged inside the first casing 122 and extending in the axial direction of the bottle 120. The moving contact 180 is configured to be displaced/moved in the axial direction relative to the first casing 122 and the bottle 120, and includes a rod portion, i.e., first rod portion 182, having a first end 184 arranged inside the bottle 120 and a second end 186 disposed inside the first casing 122. In some embodiments, the moving contact 180 also includes a disc portion, i.e., a first disc portion 188 arranged at the first end 184 of the first rod portion 182 and connected to the first rod portion 182. It may be appreciated that the moving contact 180 is made of an electrically conducting material, for aluminium or any other similar material known in the art.

To facilitate the displacement of the moving contact 180 in the axial direction of the bottle 120, the interrupter unit 110 includes an actuator rod 190 extending from an outside of the dead tank 104 to an inside of the first casing 122 through the channel 154 of the insulator tube 152, and is connected to the second end 186 of the first rod portion 182 of the moving contact 180. It may be noted that the actuator rod 190 is made of a suitable electrically insulator material to prevent the flow of electricity to the dead tank 104 and outside of the dead tank 104 from the first casing 122 and the first contact 180 through the actuator rod 190. The actuator rod 190 is moved forwardly and rearwardly in the axial direction by a suitable actuator, known in the art, to displace the first contact 180 in the axial direction relative to the bottle 120 and the first casing 122. It may be appreciated that the interrupter unit 110 may include suitable components, for example, bearings and/or bushings, to movably support the first contact 180 and the actuator rod 190.

The interrupter unit 110 further includes a second contact 192 i.e., a stationary contact 192, at least partially extending inside the bottle 120 in the axial direction of the bottle 120 and attached to the second casing 124. The second contact 192 may extends inside the second casing 124 and is attached to the second casing 124. The second contact 192 remains stationary relative to the bottle 120 and the second casing 124, and includes a rod portion, for example, a second rod portion 194, having a first end 196 arranged inside bottle 120 and a second end 198 arranged that may be disposed inside the second cavity 164 and attached to the second casing 124.

The second contact 192 further includes a disc portion, for example a second disc portion 200, attached to the second rod portion 194 and disposed at the first end 196 of the second rod portion 194. The second disc portion 200 is engaged with the first disc portion 188 to electrically connect the first conductor 112 and the second conductor 114 to close an electrical circuit, while the first disc portion 188 is moved away from the second disc portion 200 to break the electrical circuit and electrically disconnect the first conductor 112 and the second conductor 114. Accordingly, by moving the first contact 180, in axial longitudinal direction, towards and away from the second contact 192 via the actuator rod 190, while the first conductor 112 and the second conductor 114 are electrically connected with and disconnected from each other.

When the disc portions 188, 200 are arranged in contact or during engagement, disengagement of the first and disc portions 188, 200, a large amount of heat is generated at the disc portions 188, 200 which is transferred to the first casing 122 and the second casing 124 via the first and second rod portions 182, 194 through conduction mechanism. To enhance the heat transfer from the first casing 122 and the second casing 124 to an insulation gas present inside the chamber 106 of the dead tank 104, the interrupter unit 110 includes a heat transfer system 300 for removing heat from the at least one of the contacts.

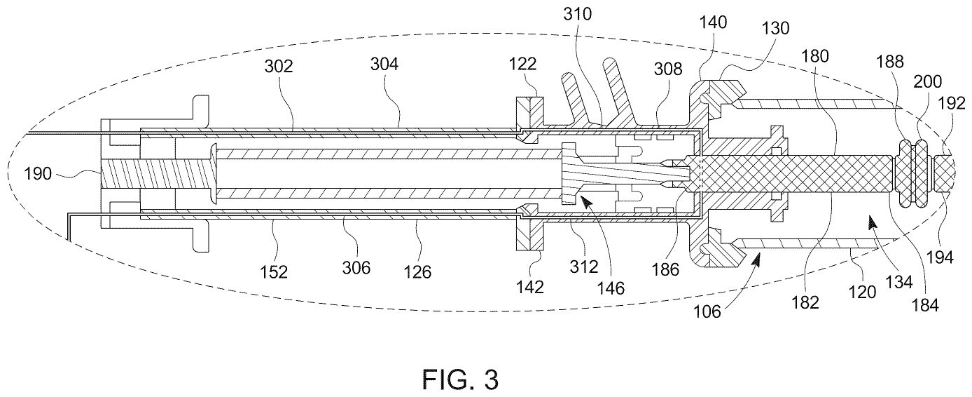

Referring to FIG. 3, the heat transfer system 300 includes an inlet passage 302 i.e., a first inlet passage 302, extending, through a wall 304 of the first ground insulator 126, from the first end of the first ground insulator 126 to the second end of the first ground insulator 126. In the embodiment, the first inlet passage 302 is arranged offset from a central axis of the channel 154 of the first ground insulator 126, and is arranged between the central channel and an outer surface of the first ground insulator 126 in a radial direction. An inlet opening of the first inlet passage 302 is defined at the first end of the first ground insulator 126, while an outlet opening of the first inlet passage 302 is defined at the second end of the first ground insulator 126.

Similarly, the heat transfer system 300 includes an outlet passage 306 i.e., second outlet passage 306, extending from the first end of the first ground insulator 126 to the second end of the first ground insulator 126 and through the wall 304 of the first ground insulator 126. In the embodiment, the second outlet passage 306 is arranged offset from the central axis of the channel 154 of the first ground insulator 126, and is arranged, in the radial direction, between the channel 154 and the outer surface of the first ground insulator 126. An inlet opening of the second outlet passage 306 is defined at the second end of the first ground insulator 126, while an outlet opening of the second outlet passage 306 disposed at the first end of the first ground insulator 126. As shown, the first inlet and outlet passages 302, 306 are arranged on opposite sides of the central axis of the channel 154 of the first ground insulator 126.

Further, the heat transfer system 300 includes a cooling channel 308 i.e., a first cooling channel 308, defined by the first casing 122. The first cooling channel 308 fluidly connects the first inlet passage 302 to the first outlet passage 306 and extends/defined through a wall of the first casing 122. In embodiments, the cooling channel 308 includes a first inlet portion 310 extending in an axial direction from the second end 142 of the first casing 122 towards the first end 140 of the first casing 122 and a first outlet portion 312 extending in an axial direction from the first inlet portion 310 to the first outlet passage 306, and fluidly connected with the outlet passage 306. It may be appreciated that the first cooling channel 308 includes a connecting portion that connects the first inlet portion 310 to the first outlet portion 312 of the first cooling channel 308. Also, it may be noted that while the first inlet and outlet portions 310, 312 extends in the axial direction of the first casing 122, at least a part of the connecting portion of the first cooling channel 308 may extend along a circumferential direction of the first casing 122. The coolant enters the first inlet portion 310 of the first cooling channel 308 from the first inlet passage 302, flows through the first inlet portion 310 and the first outlet portion 312, and the enters the outlet passage 306 from the first outlet portion 312.

Further, referring back to FIG. 2, the heat transfer system 300 includes a heat exchanger, for example, a first heat exchanger 314, arranged outside the dead tank 104 and fluidly connected with the first inlet passage 302 and the first outlet passage 306. The first heat exchanger 314 is arranged to receive the heated coolant from the first outlet passage 306, cool the coolant, and provides the cooled coolant to the first inlet passage 302. It may be appreciated that the first heat exchanger 314 is connected with the first inlet passage 302 and the first outlet passage 306 through suitable coolant lines.

In some embodiments, the heat transfer system 300 includes a fan, for example, a first fan 316, arranged to force a flow of air over the first heat exchanger 314 to increase heat transfer between air and the coolant flowing through the conduits of first heat exchanger 314. Additionally, the heat transfer system 300 may include a pump 320 arranged to pump the coolant from the first heat exchanger 314 to the first inlet passage 302 and hence to the first cooling channel 308. In the embodiment, the pump 320 is arranged downstream of the first heat exchanger 314, in a direction of flow of the coolant, and outside the dead tank 104 and fluidly connected to the first heat exchanger 314 and the first inlet passage 302. However, the pump 320 may be connected upstream of the first heat exchanger 314 and fluidly connected to the first heat exchanger 314 and the first outlet passage 306.

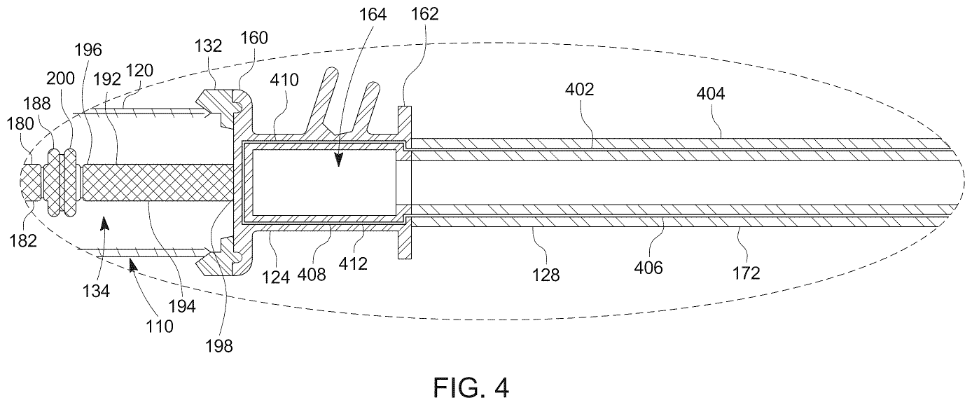

Furthermore, referring to FIG. 4, the heat transfer system 300 includes an inlet passage, for example, a second inlet passage 402, and an outlet passage i.e., the second outlet passage 406, each extending from the first end of the second ground insulator 128 to the second end of the second ground insulator 128 and through a wall 404 of the second ground insulator 128 An inlet opening of the second inlet passage 402 is defined at the first end of the second ground insulator 128, while an outlet opening of the second outlet passage 406 is defined at the first end of the second ground insulator 128. The second inlet passage 402 and the second outlet passage 406 are arranged offset from a central axis of the second ground insulator 128, and are disposed on opposite sides of the central axis of the second ground insulator 128. Moreover, in the illustrated embodiment, the second casing 124 defines a cooling channel 408, referred to as, a second cooling channel 408, of the heat transfer system 300. The second cooling channel 408 has an inlet portion 410 i.e., second inlet portion 410, fluidly connected to the second inlet passage 402 to receive the coolant from the second inlet passage 402, and an outlet portion 412 i.e., second outlet portion 412, fluidly connected to the first inlet portion 410 and the second outlet passage 406 to allow a flow to the coolant to the second outlet passage 406 from the second inlet portion 410 of the second cooling channel 408.

As shown, the second inlet portion 410 extends in the axial direction from the second end 162 of the second casing 124 towards the first end 160 of the second casing 124, while the second outlet portion 412 extends, in the axial direction, from the second inlet portion 410 to the second end 162 of the second casing 124, i.e., to second the outlet passage 406. A connecting portion of the second cooling channel 408 connects the second inlet portion 410 of the second cooling channel 408 with the second outlet portion 412 of the second cooling channel 408. The connecting portion extends at least partially along a circumferential direction of the second casing 124. The coolant enters the second inlet portion 410 of the second cooling channel 408 from the second inlet passage 402, flows through the second inlet portion 410 and the second outlet portion 412, and the enters the second outlet passage 406 from the second outlet portion 412.

Further, referring back to FIG. 2, the heat transfer system 300 includes a heat exchanger, for example, a second heat exchanger 414, arranged outside the dead tank 104 and fluidly connected with the second inlet passage 402 and the second outlet passage 406. The second heat exchanger 414 is arranged to receive the heated coolant from the second outlet passage 406, cool the coolant, and provides the cooled coolant to the second inlet passage 402. It may be appreciated that the second heat exchanger 414 is connected with the second inlet passage 402 and the second outlet passage 406 through suitable coolant lines. In some embodiments, the heat transfer system 300 includes a fan, for example, a second fan 416, arranged to force a flow of air over the second heat exchanger 414 to increase heat transfer between air and the coolant flowing through the conduits of second heat exchanger 414. Additionally, the heat transfer system 300 may include a pump 420 arranged to pump the coolant from the second heat exchanger 414 to the second inlet passage 402. In the embodiment, the pump 420 is arranged downstream of the second heat exchanger 414, in a direction of flow of the coolant, and outside the dead tank 104 and fluidly connected to the second exchanger 414 and the second inlet passage 402. However, the pump 420 may be connected upstream of the second heat exchanger 414, and fluidly connected to the second heat exchanger 414 and the second outlet passage 406.

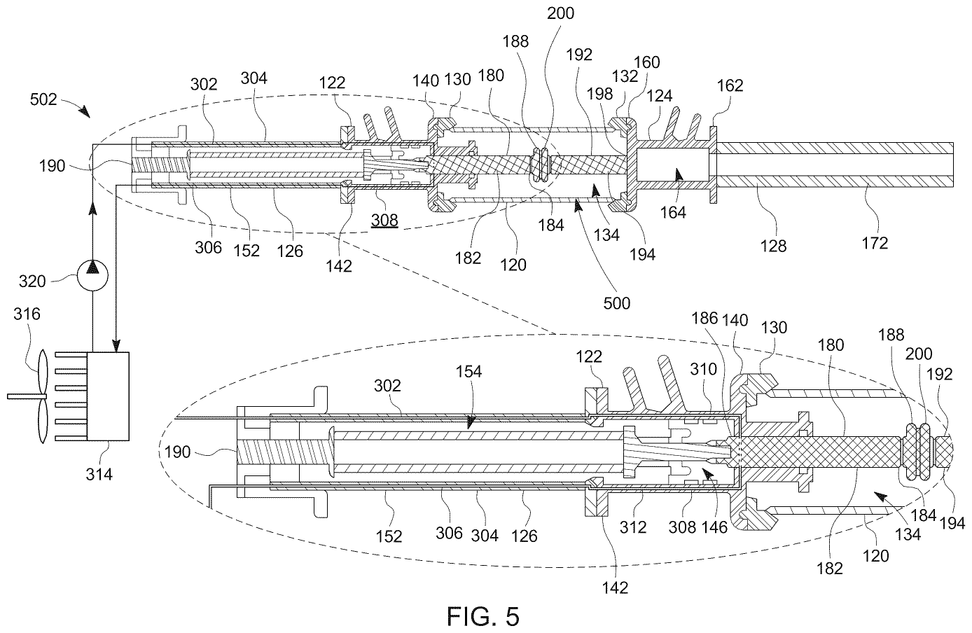

Referring to FIG. 5, an interrupter unit 500 according to alternative embodiment is shown. The interrupter unit 500 is similar to the interrupter unit 110 except that a heat transfer system 502 of the interrupter unit 500 is different from the heat transfer system 300 of the interrupter unit 110. As shown in in FIG. 5, a cooling structure for cooling the stationary contact 192 is omitted from the heat transfer system 502. Accordingly, the second heat exchanger 414, the second fan 416, the pump 420, the second inlet and outlet passages 402, 406, and the second cooling channel 408 are omitted from the heat transfer system 502 as compared to the heat transfer system 300 of the interrupter unit 110.

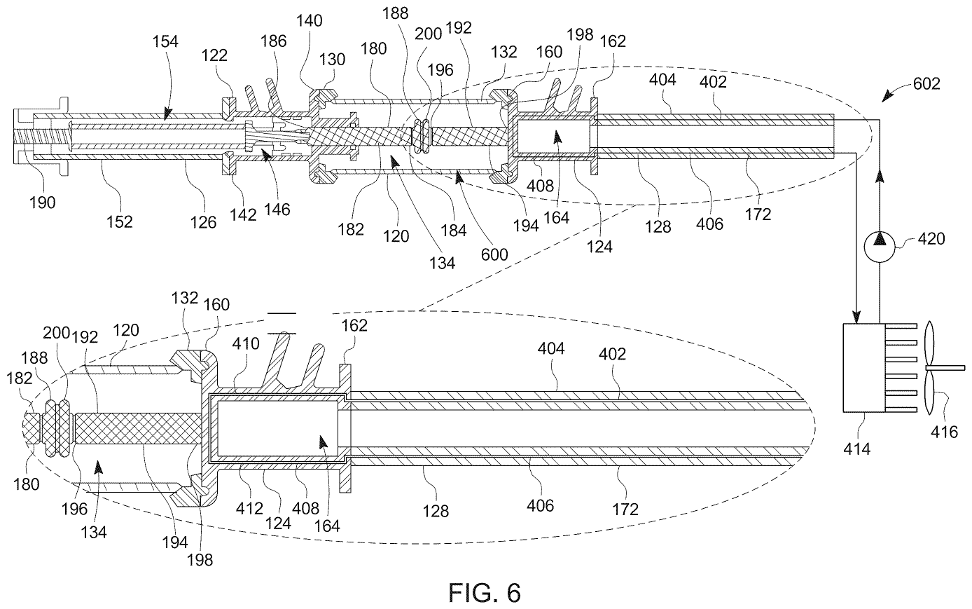

Referring to FIG. 6, an interrupter unit 600 according to alternative embodiment is shown. The interrupter unit 600 is similar to the interrupter unit 110 except that a heat transfer system 602 of the interrupter unit 600 is different from the heat transfer system 300 of the interrupter unit 110. As shown in in FIG. 6, a cooling structure for cooling the moving contact 180 is omitted from the heat transfer system 602, and the heat transfer system 602 includes a cooling structure to cool the stationary contact 192. Accordingly, the first heat exchanger 314, the first fan 316, the pump 320, the first inlet and outlet passages 302, 306, and the first cooling channel 308 are omitted from the heat transfer system 602 as compared to the heat transfer system 300 of the interrupter unit 110.

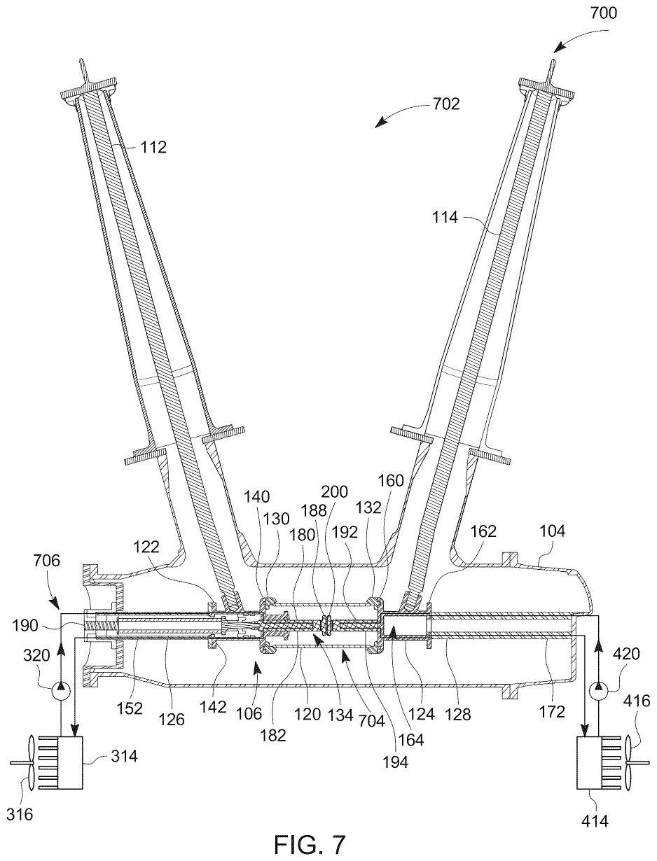

Referring to FIG. 7, a vacuum circuit breaker 700 is shown according to an embodiment of the disclosure. The vacuum circuit breaker 700 is a dead tank type vacuum circuit breaker 702 and is similar to the vacuum circuit breaker 100 except that an interrupter unit 704 of the vacuum circuit breaker 700 is different from the interrupter unit 110 of the vacuum circuit breaker 100. The interrupter unit 704 is similar to the interrupter unit 110 except that a heat transfer system 706 of the interrupter unit 704 is different from heat transfer system 300 of the interrupter unit 110 except that a first cooling channel 708 and a second cooling channel 808 of the heat transfer system 706 are different from the first and second cooling channels 308, 408 of the heat transfer system 300, and the heat transfer system 706 additionally includes a first elongated groove 720 defined by the first contact 180 i.e., moving contact 180, and a second elongated groove 820 defined by the second contact 192 i.e., stationary contact 192, to allow flow of coolant through the contacts 180, 192.

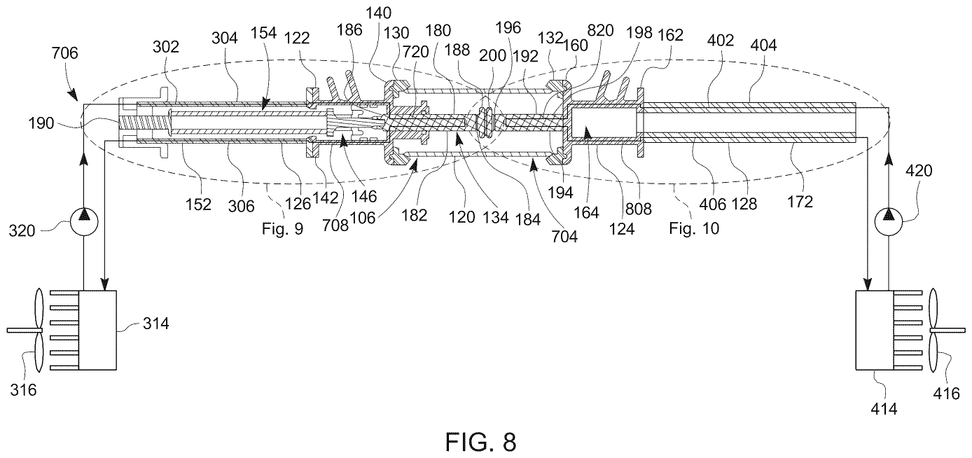

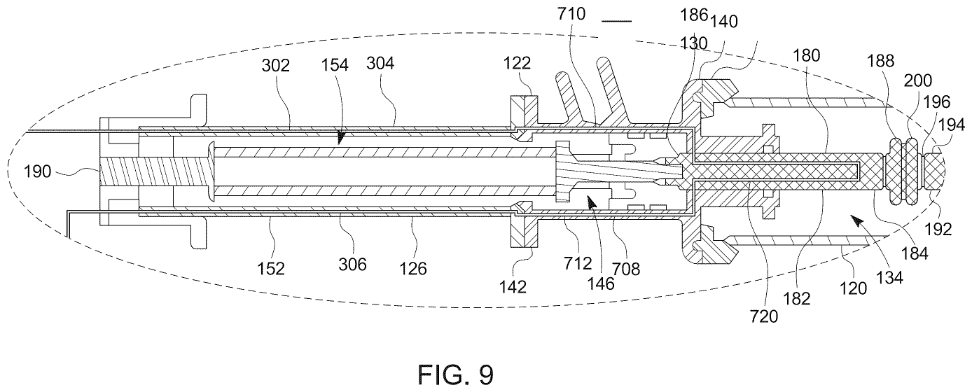

As shown in FIGS. 8 and 9, the first cooling channel 308 includes a first inlet portion 710 fluidly connected to the first inlet passage 302 to receive the coolant from the first inlet passage 302, and a first outlet portion 712 fluidly connected to the first outlet passage 306 to provide the coolant to the first outlet passage 306. In the embodiment, the first inlet portion 710 extends from the second end 142 of the first casing 122 to the first end 140 of the first casing 122, and through a wall of the first casing 122, while the first outlet portion 712 extends from the first end 140 of the first casing 122 to the first outlet passage 306, and through the wall of the first casing 122. The first inlet portion 710 and the first outlet portion 712 are connected to each other via the first elongated groove 720. Accordingly, the coolant flows to the first outlet portion 712 from the first inlet portion 710 via the first elongated groove 720. As shown, the first elongated groove 720 extends, in a serpentine shape or horizontally oriented U shape, through the first rod portion 182 of the moving contact 180 with a first port of the first elongated groove 720 arranged fluidly connected to the first inlet portion 710 and a second port of the first elongated groove 720 arranged fluidly connected to the first outlet portion 712 of the first cooling channel 708. Accordingly, the coolant flows from the first heat exchanger 314 to the first inlet passage 302, then to the first elongated groove 720 via the first inlet portion 710 of the first cooling channel 708, and then to the first outlet portion 712 from the first groove 720, and moves back to the first heat exchanger 314 via the first outlet passage 306.

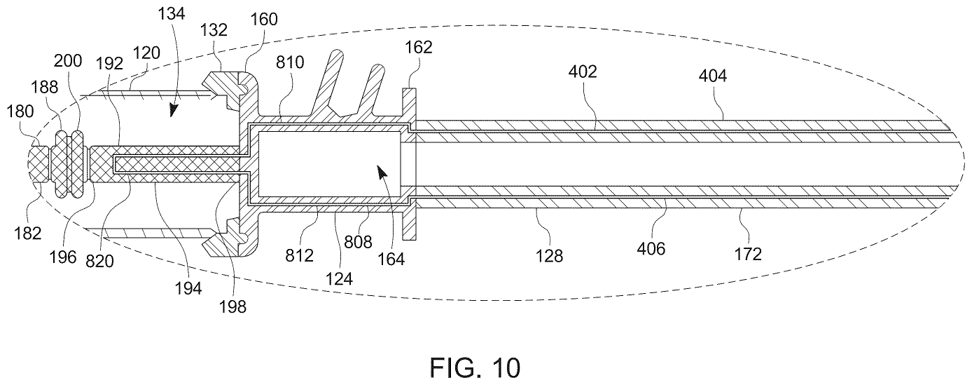

Similarly, referring to FIG. 10, the second cooling channel 808 includes a second inlet portion 810 fluidly connected to the second inlet passage 402 to receive the coolant from the second inlet passage 402, and a second outlet portion 812 fluidly connected to the second outlet passage 806 to provide the coolant to the second outlet passage 806. In the embodiment, the second inlet portion 810 extends from the second end 162 of the second casing 124 to the first end 160 of the second casing 124, and through a wall of the second casing 124, while the second outlet portion 812 extends from the first end 160 of the second casing 124 to the second outlet passage 806, and through the wall of the second casing 124. The second inlet portion 810 and the second outlet portion 812 are connected to each other via the second elongated groove 820. Accordingly, the coolant flows to the second outlet portion 812 from the second inlet portion 810 via the second elongated groove 820.

As shown in FIGS. 8 and 10, the second elongated groove 820 extends, in a serpentine shape or horizontally oriented U shape, through the second rod portion 194 of the stationary contact 192 with a first port of the second elongated groove 820 arranged fluidly connected to the second inlet portion 810 and a second port of the second elongated groove 820 arranged fluidly connected to the second outlet portion 812 of the second cooling channel 808. Accordingly, the coolant flows from the second heat exchanger 414 to the second inlet passage 402, then to the second elongated groove 820 via the second inlet portion 810 of the second cooling channel 808, and then to the second outlet portion 812 from the second groove 820, and moves back to the second heat exchanger 414 via the second outlet passage 406.

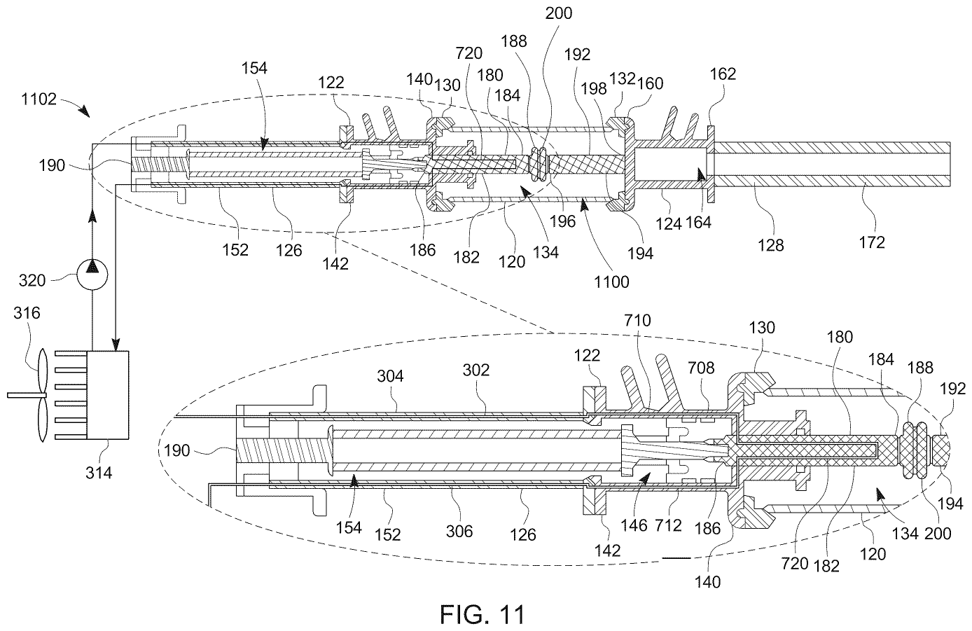

Referring to FIG. 11, an interrupter unit 1100 according to alternative embodiment is shown. The interrupter unit 1100 is similar to the interrupter unit 704 except that a heat transfer system 1102 of the interrupter unit 1100 is different from the heat transfer system 706 of the interrupter unit 704. As shown in in FIG. 11, a cooling structure for cooling the stationary contact 192 is omitted from the heat transfer system 1102. Accordingly, the second heat exchanger 414, the second fan 416, the pump 420, the second inlet and outlet passages 402, 406, the second cooling channel 808, and the second elongated groove 820 are omitted from the heat transfer system 1102 as compared to the heat transfer system 706 of the interrupter unit 704.

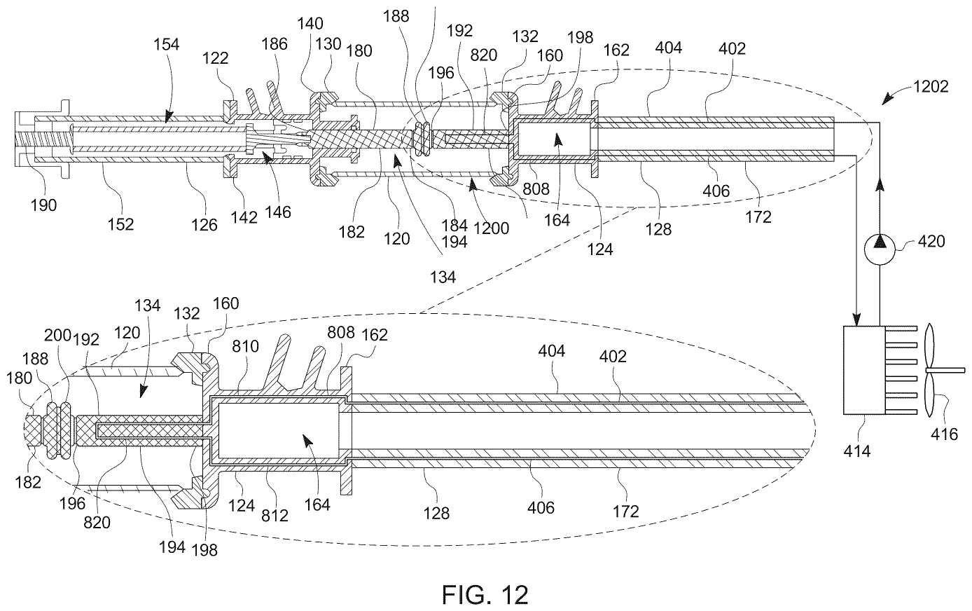

Referring to FIG. 12, an interrupter unit 1200 according to alternative embodiment is shown. The interrupter unit 1200 is similar to the interrupter unit 704 except that a heat transfer system 1202 of the interrupter unit 1200 is different from the heat transfer system 706 of the interrupter unit 704. As shown in in FIG. 12, a cooling structure for cooling the moving contact 180 is omitted from the heat transfer system 1202, and the heat transfer system 1202 includes a cooling structure to cool the stationary contact 192. Accordingly, the first heat exchanger 314, the first fan 316, the pump 320, the first inlet and outlet passages 302, 306, the first cooling channel 708, and the first elongated groove 720 are omitted from the heat transfer system 1202 as compared to the heat transfer system 706 of the interrupter unit 704.

The flow of coolant facilitates in effective removal of the heat from the contacts 180, 192 and other components of the vacuum circuit breaker. Also, the coolant that is used for removing heat includes a dielectric strength comparable to the dielectric strength of the associated ground insulator 126, 128 to prevent generation of electric flashes in the proximity of the inlet and outlet passages of the associated ground insulator 126, 128. In an embodiment, the dielectric strength of the coolant used for removing heat is between ninety percent and one hundred and ten percent of the dielectric strength of the associated ground insulator 126, 128. In example embodiments, the coolant may be oil based coolant, such as, but not limited to, mineral oil, silicone oil, synthetic esters, etc.

As the lower temperatures of the components of the vacuum circuit breaker 100, 700 can be maintained, overall working life of the vacuum circuit breaker 100, 700 is increased relative to the convention vacuum circuit breaker. Further, the vacuum circuit breaker 100, 700 can be operated with reduced maintenance and provides less down time. Moreover, as the components of the breaker 100, 700 operates at relatively lower temperatures, materials of the components that can withstand high temperatures may be replaced with suitable materials that can withstand relatively lower temperatures, reducing overall cost of the vacuum circuit breaker 100, 700.

It should be understood that the foregoing description is only illustrative of the aspects of the disclosed embodiments. While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. Various alternatives and modifications can be devised by those skilled in the art without departing from the aspects of the disclosed embodiments. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

### LIST Of ELEMENTS

100 vacuum circuit breaker
102 dead tank vacuum circuit breaker
104 dead tank
106 chamber
110 interrupter unit
112 first conductor
114 second conductor
120 vacuum sealed bottle
122 first conductor casing
124 second conductor casing
126 first ground insulator
128 second ground insulator
130 first axial end
132 second axial end
134 compartment
140 first end
142 second end
146 first cavity
152 insulator tube
154 channel
160 first end
162 second end
164 second cavity
172 insulator rod
180 moving contact
182 first rod portion
184 first end
186 second end
188 first disc portion
190 actuator rod
192 stationary contact
194 second rod portion
196 first end
198 second end
200 second disc portion
300 heat transfer system
302 first inlet passage
304 wall
306 first outlet passage
308 first cooling channel
310 first inlet portion
312 first outlet portion
314 first heat exchanger
316 first fan
320 pump
402 second inlet passage
404 wall
406 second outlet passage
408 second cooling channel
410 second inlet portion
412 second outlet portion
414 second heat exchanger
416 second fan
420 pump
500 interrupter unit
502 heat transfer system
600 interrupter unit
602 heat transfer system
700 vacuum circuit breaker
702 dead tank vacuum circuit breaker
704 interrupter unit
706 heat transfer system
708 first cooling channel
710 first inlet portion
712 first outlet portion
720 first elongated groove
808 second cooling channel
810 first inlet portion
812 second inlet portion
820 second elongated groove
1100 interrupter unit
1102 heat transfer system
1200 interrupter unit
1202 heat transfer system

What is claimed is:

1. An interrupter unit adapted to be arranged inside a dead tank and supported on the dead tank, the interrupter unit comprising:
a vacuum sealed tube;
a pair of conductor casings attached to the vacuum sealed tube and extending outwardly and along a central axis of the vacuum sealed tube, wherein the vacuum sealed tube is arranged between the pair of conductor casings, and at least one of the pair of conductor casings defines a cooling channel; and
a pair of ground insulators extending from the dead tank to the pair of conductor casings along the central axis of the vacuum sealed tube and supporting the pair of conductor casings on the dead tank, wherein at least one of the pair of ground insulators defines;
an inlet passage fluidly coupled to the cooling channel to provide a coolant to the cooling channel, and
an outlet passage fluidly coupled to the coolant channel to receive the coolant from the coolant channel.

2. The interrupter unit of claim 1 further comprises a pump to supply the coolant to the cooling channel through the inlet passage to remove heat from the at least one of the pair of conductor casings.

3. The interrupter unit of claim 2 further comprises a heat exchanger arranged fluidly connected to the pump and the outlet passage and configured to cool the coolant received from the outlet passage and provide the cooled coolant to the pump.

4. The interrupter unit of claim 1, wherein the coolant includes a dielectric strength that is between ninety percent and hundred and ten percent of a dielectric strength of the at least one of the pair of ground insulators.

5. The interrupter unit of claim 1, wherein at least one of the pair of conductor casings includes a first conductor casing and the least one of the pair of ground insulators includes a first ground insulator arranged extending from the dead tank to the first conductor casing, and contacting the first conductor casing, wherein the interrupter unit further comprises:
a moving contact movably and partially arranged inside the vacuum sealed tube and partially extending inside the first conductor casing, wherein the moving contact is displaced to close and open an electric circuit.

6. The interrupter unit of claim 5, wherein the cooling channel includes an inlet portion arranged to receive the coolant from the inlet passage and an outlet portion arranged connected to the outlet passage to provide the coolant to the outlet passage, wherein the moving contact defines a groove fluidly connected to the inlet portion and the outlet portion.

7. The interrupter unit of claim 1, wherein at least one of the pair of conductor casings includes a second conductor casing and the least one of the pair of ground insulators includes a second ground insulator arranged extending from the dead tank to the second conductor casing, and contacting the second conductor casing, wherein the interrupter unit further comprises:
a stationary contact non-movably arranged inside the vacuum sealed tube and disposed connected to the second conductor casing.

8. The interrupter unit of claim 7, wherein the cooling channel includes an inlet portion arranged to receive the coolant from the inlet passage and an outlet portion arranged connected to the outlet passage to provide the coolant to the outlet passage, wherein the stationary contact includes a groove fluidly connected to the inlet portion and the outlet portion.

9. A vacuum circuit breaker, comprising:
a dead tank defining a chamber; and
an interrupter unit arranged inside the chamber and comprises:
a vacuum sealed tube,
a pair of conductor casings attached to the vacuum sealed tube and extending outwardly and along a central axis of the vacuum sealed tube, wherein the vacuum sealed tube is arranged between the pair of conductor casings, and at least one of the pair of conductor casing defines a cooling channel, and
a pair of ground insulators extending from the dead tank to the pair of conductor casings along the central axis of the vacuum sealed tube and supporting the pair of conductor casings on the dead tank, wherein at least one of the pair of ground insulators defines:
an inlet passage fluidly coupled to the cooling channel to provide a coolant to the cooling channel, and
an outlet passage fluidly coupled to the cooling channel to receive the coolant from the coolant channel.

10. The vacuum circuit breaker of claim 9 further comprises a pump to supply the coolant to the cooling channel through the inlet passage to remove heat from the at least one of the pair of conductor casings.

11. The vacuum circuit breaker of claim 10 further comprises a heat exchanger arranged fluidly connected to the pump and the outlet passage and configured to cool the coolant received from the outlet passage and provide the cooled coolant to the pump.

12. The vacuum circuit breaker of claim 9, wherein the coolant includes a dielectric strength that is between ninety percent and hundred and ten percent of a dielectric strength of the at least one of the pair of ground insulators.

13. The vacuum circuit breaker of claim 9, wherein at least one of the pair of conductor casings includes a first conductor casing and the least one of the pair of ground insulators includes a first ground insulator arranged extending from the dead tank to the first conductor casing, and contacting the first conductor casing, wherein the interrupter unit further comprises:
a moving contact movably and partially arranged inside the vacuum sealed tube and partially extending inside the first conductor casing, wherein the moving contact is displaced to close and open an electric circuit.

14. The vacuum circuit breaker of claim 13, wherein the cooling channel includes an inlet portion arranged to receive the coolant from the inlet passage and an outlet portion arranged connected to the outlet passage to provide the coolant to the outlet passage, wherein the moving contact defines a groove fluidly connected to the inlet portion and the outlet portion.

15. The vacuum circuit breaker of claim 9, wherein at least one of the pair of conductor casings includes a second conductor casing and the least one of the pair of ground insulators includes a second ground insulator arranged extending from the dead tank to the second conductor casing, and contacting the second conductor casing, wherein the interrupter unit further comprises:
a stationary contact non-movably arranged inside the vacuum sealed tube and disposed connected to the second conductor casing.

16. The vacuum circuit breaker of claim 15, wherein the cooling channel includes an inlet portion arranged to receive the coolant from the inlet passage and an outlet portion arranged connected to the outlet passage to provide the coolant to the outlet passage, wherein the stationary contact includes a groove fluidly connected to the inlet portion and the outlet portion.
